(19) United States
(12) Patent Application Publication
(10) Pub. No.: US 2004/0033828 A1
(43) Pub. Date: Feb. 19, 2004

(54) Stroboscopic effect for displaying slot reel positions of a gaming machine

(76) Inventor: Mark B. Gagner, West Chicago, IL (US)

Correspondence Address: Michael J. Blankstein, WMS Gaming Inc., 800 South Northpoint Boulevard, Waukegan, IL, 60085, US

(21) Appl. No.: 10/223,506

(22) Filed: Aug. 19, 2002

(51) Int. Cl. G06F 17/00

(52) U.S. Cl. 463/20

(57) ABSTRACT

A gaming machine for conducting a wagering game includes a physical rotating reel, a strobe for illuminating the reel, and a control system for triggering the strobe. The reel includes a perimeter and a plurality of symbol positions along the perimeter. The control system triggers the strobe when a selected portion of the perimeter is at a display area generally within a view of a player. The machine design can be used to create new opportunities for reel movement and player anticipation and excitement while lessening the processing burden on the control system.

### FIELD OF THE INVENTION

The present invention relates generally to reel spinning gaming machines and, more particularly, to a reel spinning gaming machine that displays positions of its mechanical reels using a stroboscopic effect.

### BACKGROUND OF THE INVENTION

A reel spinning gaming machine generally comprises a plurality of physical spinning reels. Each reel is basically a cylinder with a sequence of symbols arranged around its circumference. In response to a wager, a controller randomly selects an outcome from a plurality of possible outcomes and then presents the selected outcome by rotating the reels to pre-defined positions that expose a particular combination of symbols to the player. Each unique combination of symbols represents a different game outcome with a potentially different value. If the selected outcome corresponds to a winning outcome identified on a pay table, the controller instructs a payoff mechanism to award a payoff for that winning outcome to the player in the form of coins or credits.

The spinning reels serve two primary functions. First, the spinning reels present or display a particular combination of symbols to the player to indicate the selected outcome of a game. Second, the spinning reels create a sense of anticipation and excitement within the player through controlled motion of the reels. The sense of anticipation and excitement is enhanced when symbols associated with winning combinations are observed. To create the sense of anticipation and excitement, the controller precisely controls the velocity (e.g., acceleration, deceleration, and peak speed) and final stopping position of motors that are used to drive the respective reels. The motors are typically stepper motors. This precise control of multiple motors is a significant processing burden on the controller and complicates the machine design. It would be desirable to create the sense of anticipation and excitement and to have the ability to create new opportunities for reel movement and player excitement with a simpler machine design that lessens the processing burden on the controller.

### SUMMARY OF THE INVENTION

A gaming machine for conducting a wagering game includes a physical rotating reel, a strobe for illuminating the reel, and a control system for triggering the strobe. The reel includes a perimeter and a plurality of symbol positions along the perimeter. The control system triggers the strobe when a selected portion of the perimeter is at a display area generally within a view of a player. The machine design can be used to create new opportunities for reel movement and player anticipation and excitement while lessening the processing burden on the control system.

### BRIEF DESCRIPTION OF THE DRAWINGS

The foregoing and other advantages of the invention will become apparent upon reading the following detailed description and upon reference to the drawings.

FIG. 1 is a perspective view of a reel spinning gaming machine operable to conduct a wagering game.

FIG. 2 is a block diagram of a control system for controlling the display of a selected position on a reel of the gaming machine using a stroboscopic effect.

FIG. 3 is a diagrammatic representation of an alternative reel mechanism that can be used to display selected reel positions using the stroboscopic effect.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

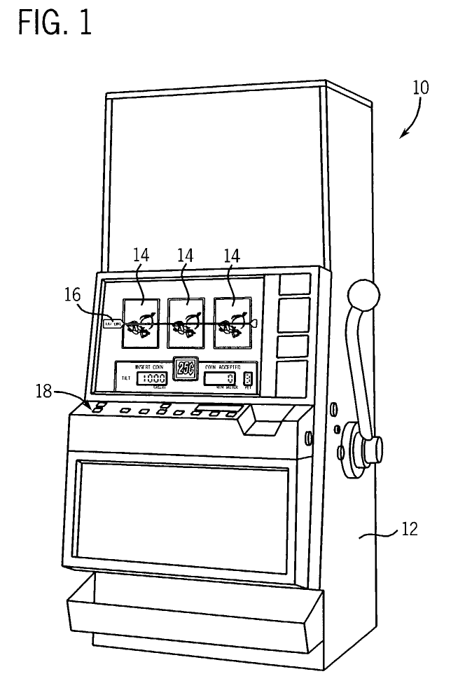

Turning now to the drawings, FIG. 1 depicts a reel spinning gaming machine 10 for conducting a slot game. The gaming machine includes a cabinet 12 and a plurality of physical spinning reels 14 housed within the cabinet 12. Each reel 14 is basically a cylinder with a sequence of symbols arranged around its perimeter or circumference. In response to a wager, a control system randomly selects an outcome from a plurality of possible outcomes and then presents the selected outcome by displaying a particular combination of symbols to the player. The combination of symbols may be displayed in visual association with at least one pay line 16. Each unique combination of symbols represents a different game outcome with a potentially different value. If the selected outcome corresponds to a winning outcome identified on a pay table, the control system instructs a payoff mechanism to award a payoff for that winning outcome to the player in the form of coins or credits. The player may operate a button panel 18 to place wagers, activate a number of pay lines if more than one pay line is possible, initiate apparent motion of the reels 14, and collect any credits accumulated on the game's credit meter.

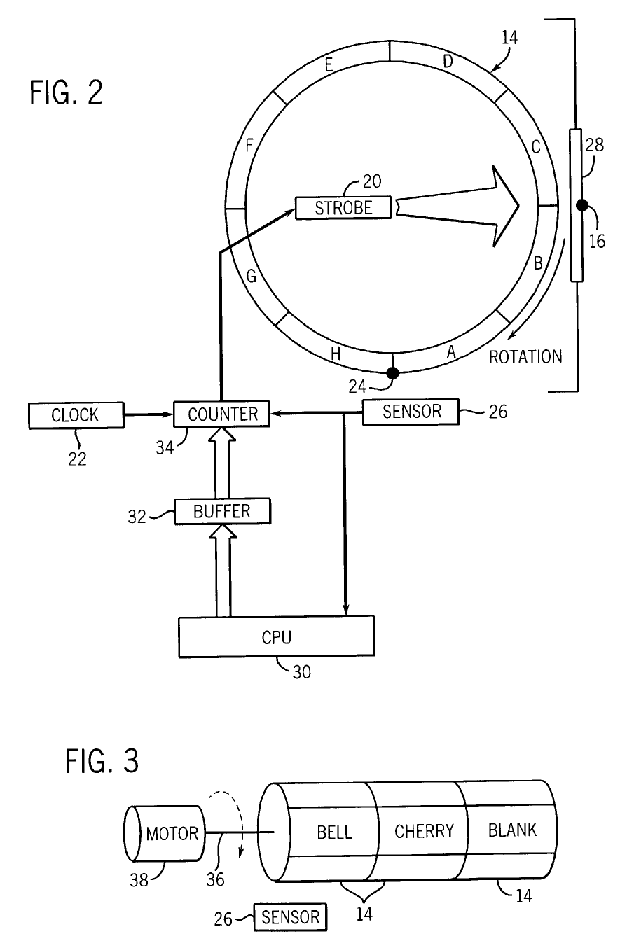

FIG. 2 is a block diagram of a control system suitable for controlling the display of a selected position on a reel 14 of the gaming machine 10 using a stroboscopic effect. The stroboscopic effect is used to create or freeze the apparent motion of the reel 14 as it rotates in a regular and predictable manner. A strobe 20 produces a very brief pulse of light. Because the reel 14 is illuminated for only a brief instant, its motion appears “frozen.” The control system preferably drives the reel 14 at a continuous fixed speed. The control system does not accelerate (i.e., ramp up), decelerate (i.e., ramp down), or stop the reel 14. The timing of the strobe 20 is used to create apparent motion and the appearance of a final stopped position.

The human eye has a response time of about 1/15 second to 1/30 second. To create the appearance of continuous motion, the strobe 20 is triggered (i.e., fired) at a minimum rate of approximately 30 pulses per second (PPS). The face of the gaming machine preferably blocks ambient light to insure that no symbols on the reel 14 are visible if the strobe 20 or the reel 14 fails. The strobe 20 is preferably positioned to optimally illuminate a viewable portion of the reel 14, i.e., the portion of the reel 14 viewable through a display window 28. In one embodiment, the strobe 20 is mounted inside the reel 14 on an axis drawn from the center of the reel 14 to the center pay line 16.

Apparent motion (or lack of motion) of the constantly spinning reel is achieved by synchronizing the strobe pulse with a selected location on the reel 14. The strobe is triggered when the selected location on the reel 14 is centered within the view of the player (i.e., centered on the pay line 16). The synchronization technique described herein is based on the use of a fixed clock 22, i.e., a clock that operates at a fixed frequency. It, however, will be apparent to one of ordinary skill in the art that there are many techniques available for achieving the required synchronization. FIG. 2 illustrates the use of a strobe 20 to illuminate the reel 14 and the use of a fixed clock 22 to trigger the strobe 20 at a selected instant of time that corresponds with the desired reel position.

The illustrated example assumes that the reel 14 spins at a fixed angular velocity. Therefore, each reel position corresponds to a precise, well-defined time interval following a reel home position 24 (start position). Because the time interval is predetermined and repeatable, synchronization of the strobe 20 can be accomplished with a fixed clock 22. It should be understood that there are other methods for achieving synchronization that do not depend upon the reel 14 spinning at a fixed angular velocity or the use of a fixed clock 22.

The time interval between the home position 24 and the appearance of any desired reel position remains constant. For simplicity, the diagram of FIG. 2 illustrates a single reel 14 with eight positions labeled A through H. As the reel 14 spins, a home position sensor 26 detects the home position 24 on the reel 14 as it passes the sensor 26. Following this event, each reel position appears in front of the strobe 20 in sequence at a well-known and predetermined interval.

For the sake of discussion, the clock 22 operates at a frequency such that there are ten clock pulses per reel position. This means that there will be exactly 80 clock pulses for each revolution of the reel 14. In this case, the center of position A will appear in front of the strobe 20 after precisely five clock pulses, the center of position B will appear after fifteen clock pulses, the center of position C will appear after 25 clock pulses, and so forth as shown in the table below:

| Position | Counts |
|---|---|
| A | 5 |
| B | 15 |
| C | 25 |
| D | 35 |
| E | 45 |
| F | 55 |
| G | 65 |
| H | 75 |

To cause a particular reel position to be illuminated and therefore visible to a player through a display window 28, the strobe 20 is synchronized to fire at the precise instant the reel position passes in front of the strobe 20. To accomplish this, a processing unit (CPU) 30 loads an appropriate predetermined count value into a buffer 32 prior to the start of the next revolution of the reel 14. The start of a revolution is defined by detection of the home position 24 by the sensor 26. At the start of the next revolution, the buffer 32 loads the count value into a counter 34. As the reel 14 rotates, the clock 22 causes the counter 34 to decrement from the loaded count value at a fixed rate that precisely matches the rate of rotation. When the count value reaches zero, the counter 34 triggers the strobe 20 to momentarily freeze the apparent motion of the reel 14 at the desired location.

To create the appearance of a stopped reel 14, the CPU 30 does nothing. At the start of each revolution, the buffer 32 loads the same count value into the counter 34 so that the same reel position is displayed repeatedly. This creates the appearance of a stationary reel.

To create the appearance of motion of the reel 14 at a particular fixed speed, the CPU 30 changes (add to or subtracts from) the loaded count value by a fixed amount at the start of each revolution of the reel 14. In the example below, the actual speed of the reel 14 is set at 30 revolutions per second. If the CPU 30 adds five (i.e., one half of the distance between two adjacent reel positions) to the count value loaded into the counter 34 at the start of each revolution, then it will appear as though the reel 14 has moved one half of a reel position in 1/30^{th} of a second. After two actual revolutions (i.e., 1/15^{th} of a second) of the reel 14, it will appear as though the reel 14 has moved one full reel position. Because there are eight positions on the illustrated reel 14, it will require 8/15 of a second to create the appearance of the reel 14 moving though one complete rotation. This corresponds to 15/8 or 1.875 revolutions per second, which equals 112.5 revolutions per minute (RPM).

The following table lists the apparent speed of the reel 14 obtained by adding particular values to the counter 34 at the start of each revolution. The table shows the apparent speed for the illustrated eight-position reel 14 and for a twenty-position reel.

| | Apparent | Apparent |
|---|---|---|
| Increment | RPM | RPM |
| Count | (8 position) | (20 position) |
| 0 | 0 | 0 |
| | (stationary) | (stationary) |
| 1 | 22.5 | 9 |
| 2 | 45 | 18 |
| 3 | 67.5 | 27 |
| 4 | 90 | 36 |
| 5 | 112.5 | 45 |
| 6 | 135 | 54 |
| 7 | 157.5 | 63 |
| 8 | 180 | 72 |
| 9 | 202.5 | 81 |
| 10 | 225 | 90 |

In this example the CPU 30 updates the counter 34 at the start of each revolution of the reel 14. It should be noted that lower apparent speeds are obtained if the counter 34 is updated after every other revolution or after every third revolution. It should also be noted that intermediate speeds are obtained by alternating the amount on alternate updates.

To create the appearance of acceleration of the reel 14, the CPU 30 changes the loaded count value by an increasing amount at the start of each successive revolution of the reel 14. To create the appearance of deceleration of the reel 14, the CPU 30 changes the loaded count value by a decreasing amount at the start of each successive revolution of the reel 14.

To create the appearance of movement of the reel 14 to a particular location, the CPU 30 loads a sequence of count values corresponding to intermediate reel positions on successive revolutions, similar to an animation. For example, to create the appearance of movement from position A to position B, the CPU 30 would successively load the counter 34 with intermediate count values ranging from five (the center of position A) to fifteen (the center of position B).

To create the appearance of movement of the reel 14 to a particular reel position instantaneously, the CPU 30 loads the counter 34 with the count value corresponding to the desired reel position. This creates the appearance of the reel 14 instantly “snapping” to the new position.

Using the stroboscopic effect to display positions on a slot reel, the burden on the CPU 30 is significantly reduced relative to controlling the actual speed of a stepper motor. The CPU 30 can easily control five or more reels, thereby reducing cost of manufacture of the gaming machine. If each reel 14 is driven by a separate motor, each reel 14 would be associated with a separate strobe 20, home sensor 26, buffer 32, and counter 34, but may share the clock 22 and CPU 30. Alternatively, as shown in FIG. 3, all of the reels 14 may be tied together on a common axis or drum 36 and driven from a single motor 38 at a fixed rotational speed. With a single drum 36, the multiple reels 14 may share a common motor 38, clock 22, home sensor 26, and CPU 30. This simplifies both the mechanical and electrical design and further reduces cost.

While the present invention has been described with reference to one or more particular embodiments, those skilled in the art will recognize that many changes may be made thereto without departing from the spirit and scope of the present invention. For example, the counter 34 may be replaced with a different counting apparatus including both a counter and a comparator. The counter may start at zero and cause the comparator to trigger the strobe 20 when the counter counts up to and reaches a selected count value. Each of these embodiments and obvious variations thereof is contemplated as falling within the spirit and scope of the claimed invention, which is set forth in the following claims:

What is claimed is:

1. A gaming machine for conducting a wagering game, comprising:
a physical rotating reel including a perimeter and a plurality of symbol positions along the perimeter;
a strobe for illuminating the reel; and
a control system for triggering the strobe when a selected portion of the perimeter is at a display area generally within a view of a player.

2. The machine of claim 1, wherein the control system includes a processing apparatus, a counting apparatus, and a clock, wherein in response to detecting a predefined reel position defining a start of a revolution:
the processing apparatus loads a count value into the counting apparatus; and
the counting apparatus, responsive to a signal from the clock, counts the loaded value and triggers the strobe after counting the loaded value.

3. The machine of claim 2, wherein the clock operates at a fixed frequency.

4. The machine of cliam 2, wherein the control system includes a sensor for detecting the predefined position on the reel.

5. The machine of claim 2, wherein the loaded count value at the start of each revolution is the same so that the reel appears stationary.

6. The machine of claim 2, wherein the loaded count value at the start of each revolution is different so that the reel appears to be moving.

7. The machine of claim 6, wherein the loaded count value changes by a fixed amount at the start of each revolution so that the reel appears to be moving at a fixed speed.

8. The machine of claim 6, wherein the loaded count value changes by an increasing amount at the start of each revolution so that the reel appears to accelerate.

9. The machine of claim 6, wherein the loaded count value changes by a decreasing amount at the start of each revolution so that the reel appears to decelerate.

10. The machine of claim 1, wherein the reel rotates at a fixed angular velocity so that a time interval between the appearance of each symbol position at the display area and the appearance of a predefined position on the reel at the display area is constant.

11. The machine of claim 1, wherein the control system triggers the strobe each time the selected portion of the perimeter is at the display area so that the reel appears stationary.

12. The machine of claim 1, further including a motor, coupled to the reel, for rotating the reel.

13. A method of displaying a position on a physical reel of a gaming machine, the reel including a perimeter and a plurality of symbol positions along the perimeter, the method comprising:
rotating the reel;
providing a strobe for illuminating the reel; and
triggering the strobe when a selected portion of the perimeter is at a display area generally within a view of a player.

14. The method of claim 13, wherein in response to detecting a predefined reel position defining a start of a revolution, the step of triggering the strobe includes:
loading a count value into a counting apparatus;
counting the loaded value; and
triggering the strobe after counting the loaded value.

15. The method of claim 14, wherein the loaded count value at the start of each revolution is the same so that the reel appears stationary.

16. The method of claim 14, wherein the loaded count value at the start of each revolution is different so that the reel appears to be moving.

17. The method of claim 16, wherein the loaded count value changes by a fixed amount at the start of each revolution so that the reel appears to be moving at a fixed speed.

18. The method of claim 16, wherein the loaded count value changes by an increasing amount at the start of each revolution so that the reel appears to accelerate.

19. The method of claim 16, wherein the loaded count value changes by a decreasing amount at the start of each revolution so that the reel appears to decelerate.

20. The method of claim 13, wherein the step of rotating the reel including rotating the reel at a fixed angular velocity so that a time interval between the appearance of each symbol position at the display area and the appearance of a predefined position on the reel at the display area is constant.

21. The method of claim 13, wherein the step of triggering the strobe includes triggering the strobe each time the selected portion of the perimeter is at the display area so that the reel appears stationary.

22. A gaming machine for conducting a wagering game, comprising:
a physical rotating reel including a perimeter and a plurality of symbol positions along the perimeter;
a strobe for illuminating the reel; and
a control system for repeatedly triggering the strobe when a selected portion of the perimeter is at a display area generally within a view of a player such that the rotating reel appears to stop with the selected portion in the display area even though the reel is still in actual motion.
